(19) United States
(12) Patent Application Publication
(10) Pub. No.: US 2026/0002818 A1
(43) Pub. Date: Jan. 1, 2026

(54) IMAGE FORMING SYSTEM, COLOR MEASUREMENT DEVICE, AND NON-TRANSITORY COMPUTER-READABLE RECORDING MEDIUM

(71) Applicant: Konica Minolta, Inc., Tokyo (JP)

(72) Inventors: Tetsuya TOYONAGA, Tokyo (JP); Daisuke GENDA, Kawasaki-shi (JP)

(21) Appl. No.: 19/243,261

(22) Filed: Jun. 19, 2025

(30) Foreign Application Priority Data
Jul. 1, 2024 (JP) 2024-105890

(51) Int. Cl. G01J 3/50; G01J 3/52

(52) U.S. Cl. CPC G01J 3/50; G01J 3/52; G01J 2003/503; G03G 2215/00063; G03G 2215/00067

(57) ABSTRACT

An image forming system includes an image forming section that prints an image on a recording medium and outputs the recording medium, a color measurement section that measures color of the image printed by the image forming section, an imaging unit that captures the image printed by the image forming section, and an analyzer that analyzes, based on the image captured by the imaging unit, whether or not the image subjected to color measurement by the color measurement section has an abnormality. When the analyzer determines that the image has an abnormality, the color measurement section does not output a color measurement result of the image having the abnormality.

### CROSS REFERENCE TO RELATED APPLICATIONS

This application is based on Japanese Patent Application No. 2024-105890 filed on Jul. 1, 2024, the contents of which are incorporated herein by reference.

### BACKGROUND OF THE INVENTION

### Technical Field

The present invention relates to an image forming system, a color measurement device, and a non-transitory computer-readable recording medium.

### Description of Related Art

In an image forming system that prints images on sheet-like recording media such as printing paper, there is known an image forming system that prints a color measurement chart including a plurality of color patches and performs color measurement on the printed color measurement chart to adjust colors at the time of printing (for example, Japanese Unexamined Patent Publication No. 2009-239529). In this conventional technology, a colorimetric value of another color patch is predicted from a colorimetric value of a part of color patches, and it is determined, based on a color difference between the predicted value and an actual colorimetric value, whether or not colorimetry has been correctly performed. For example, in a case where some of the color patches are not contaminated and the other color patches are contaminated, the conventional technology can detect that the colorimetry of the other contaminated color patches is not correctly performed.

However, in the printed color measurement chart, image noise such as density unevenness, streaks, and stains may be present in a wide range over a plurality of color patches. In the above-described conventional technology, such image noise cannot be appropriately detected, and there is a possibility that it is erroneously determined that the colorimetry of the color patch is correctly performed. Image noise included in the color measurement chart affects the color measurement result. Therefore, it is desirable not to use the colorimetric value of a color patch including image noise in adjusting the color in printing. However, since the conventional image forming system cannot appropriately detect image noise, it is difficult to accurately determine whether the colorimetry has been correctly performed.

### SUMMARY OF THE INVENTION

The present invention has been devised in order to solve the above-described conventional problems. That is, an object of the present invention is to provide an image forming system, a color measurement device, and a non-transitory computer-readable recording medium that increase color reproducibility by using only a color measurement result that has been correctly measured.

In order to achieve the above object, a first subject of the present invention is directed to an image forming system.

According to an aspect of the first subject, the image forming system includes an image forming section that prints an image on a recording medium and outputs the recording medium, a color measurement section that measures color of the image printed by the image forming section, an imaging unit that captures the image printed by the image forming section; and an analyzer that analyzes, based on the image captured by the imaging unit, whether or not the image subjected to color measurement by the color measurement section has an abnormality. When the analyzer determines that the image has an abnormality, the color measurement section does not output a color measurement result of the image having the abnormality.

A second subject of the present invention is directed to a color measurement device.

According to an aspect of the second subject, the color measurement device includes a color measurement section that measures color of an image printed on a recording medium, an imaging unit that captures the image printed on the recording medium, and an analyzer that analyzes, based on the image captured by the imaging unit, whether or not the image subjected to color measurement by the color measurement section has an abnormality. When the analyzer determines that the image has an abnormality, the color measurement section does not output a color measurement result of the image having the abnormality.

A third subject of the present invention is directed to a non-transitory computer-readable recording media recorded thereon a program to be executed by a hardware processor of a computer in a color measurement device including a color measurement section that measures color of an image printed on a recording medium and an imaging unit that captures the image printed on the recording medium.

According to an aspect of the third subject, the program recorded on the non-transitory computer-readable recording medium causes the hardware processor to perform analyzing, based on the image captured by the imaging unit, whether or not the image subjected to color measurement by the color measurement section has an abnormality, and controlling the color measurement section so as not to output, when it is determined by analyzing that the image has an abnormality, a color measurement result of the image having the abnormality

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating an example of a configuration of an image forming system;

FIG. 2 is a diagram illustrating an example of a color measurement chart printed in an image forming apparatus;

FIG. 3 is a diagram illustrating an operation example of color measurement processing by a color measurement section;

FIG. 4 is a flowchart illustrating an example of a processing procedure performed by the control unit of the image forming apparatus when execution of a color adjustment processing is instructed.

FIGS. 5A and 5B are diagrams illustrating an example of image noise;

FIG. 6 is a block diagram illustrating a functional configuration of a control unit in the color measurement device;

FIG. 7 illustrates image noise detection information;

FIG. 8 is a flowchart illustrating an example of a processing procedure by a control unit of the color measurement device;

FIG. 9 is a diagram illustrating an example of a color measurement result output from the color measurement device to the image forming apparatus

FIG. 10 is a diagram illustrating an example of a display screen of a color measurement result displayed on the display part;

FIG. 11 is a flowchart illustrating an example of a processing procedure performed by the control unit of the image forming apparatus in the second embodiment

FIG. 12 is a diagram illustrating an example of an abnormality detection chart printed in the image forming apparatus

FIG. 13 is a flowchart illustrating an example of a processing procedure by a control unit of the color measurement device;

FIG. 14 is a view illustrating an example of a display screen displayed on the display part.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

### First Embodiment

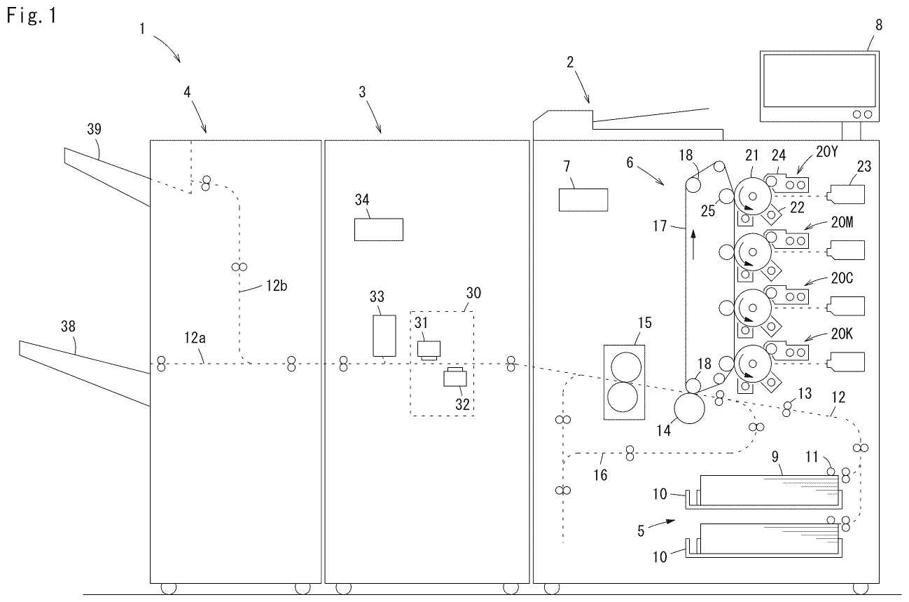

FIG. 1 illustrates an example of the configuration of an image forming system 1 according to an embodiment of the present invention. The image forming system 1 forms and outputs an image on a sheet-like recording medium 9 such as a printing sheet. The image forming system 1 includes an image forming apparatus 2, a color measurement device 3, and a sheet ejection device 4.

The image forming apparatus 2 includes, for example, a multifunction peripheral (MFP), and forms an image on a recording medium 9. The image forming apparatus 2 includes a sheet feed and conveyance section 5, an image forming section 6, a fixing section 15, a control unit 7, and a display part 8. The sheet feed and conveyance section 5 feeds and conveys the recording medium 9. The image forming section 6 forms an image on the recording medium 9 conveyed by the sheet feed and conveyance section 5. The fixing section 15 fixes the image formed on the recording medium 9. The control unit 7 is connected to the sheet feed and conveyance section 5, the image forming section 6, and the display part 8 and controls them. The control unit 7 is also connected to the color measurement device 3 and the sheet ejection device 4, and comprehensively controls operation in the image forming system 1. The display part 8 includes, for example, a color liquid crystal display, and is formed as an operation panel in which a touch screen is arranged on a display screen thereof.

The sheet feed and conveyance section 5 include a sheet feed cassette 10, a sheet feed roller 11, conveyance rollers 13, and secondary transfer rollers 14. The sheet feed cassette 10 is a container that stores the recording medium 9. The image forming apparatus 2 includes a plurality of sheet feed cassettes 10. The sheet feed and conveyance section 5 feed the recording medium 9 one by one from the sheet feed cassette 10 designated by a user among the plurality of sheet feed cassettes 10. That is, the sheet feed and conveyance section 5 feeds the recording medium 9 by driving the sheet feed roller 11 corresponding to the specified sheet feed cassette 10. The recording medium 9 fed by the sheet feed roller 11 is conveyed along a conveyance path 12. The conveyance path 12 is provided with a plurality of conveyance rollers 13. The sheet feed and conveyance section 5 conveys the recording medium 9 by rotationally driving the conveyance roller 13. The conveyance path 12 for the recording medium 9 is formed so as to extend from the image forming apparatus 2 to the color measurement device 3 and the sheet ejection device 4 in the image forming system 1.

The image forming section 6 transfers an image onto the recording medium 9 when the recording medium 9 conveyed by the sheet feed and conveyance section 5 passes through the position of the secondary transfer roller 14. The image forming section 6 generates a color image by superimposing toner images of four colors, for example, yellow (Y), magenta (M), cyan (C), and black (K), and transfers the color image to the recording medium 9. The image forming section 6 includes a plurality of image forming units 20Y, 20M, 20C, and 20K and an intermediate transfer belt 17.

The image forming units 20Y, 20M, 20C, and 20K generate toner images in respective colors of Y, M, C, and K, and primarily transfer the toner images onto the intermediate transfer belt 17. The intermediate transfer belt 17 is constituted by an endless belt, and is circulated so as to pass through the installation positions of the plurality of image forming units 20Y, 20M, 20C, and 20K.

The image forming units 20Y, 20M, 20C, and 20K have the same configuration. That is, each of the image forming units 20Y, 20M, 20C, and 20K includes an image bearing member 21 formed with a photosensitive drum or the like. Around the image bearing member 21, a charging device 22, an exposure device 23, and a developing device 24 are provided. The charging device 22 charges the surface of the image bearing member 21 to a predetermined charge. The exposure device 23 exposes the electrically charged surface of the image bearing member 123 to light to form an electrostatic latent image. The developing device 24 applies a developer containing toner to the surface of the image bearing member 21 and develops the electrostatic latent image with the toner. Thus, a toner image is formed on the surface of the image bearing member 21.

Inside the intermediate transfer belt 17, a primary transfer roller 25 is provided at a position facing the image bearing member 21 of each of the image forming units 20Y, 20M, 20C, and 20K. The primary transfer roller 25 presses the intermediate transfer belt 17 against the image bearing member 21, and by application of a predetermined voltage, primarily transfers the toner image formed on the surface of the image bearing member 21 onto the intermediate transfer belt 17. The image forming units 20Y, 20M, 20C, and 20K sequentially primary-transfer the toner images in the colors Y, M, C, and K onto the intermediate transfer belt 17. As the result, a color image is formed on the surface of the intermediate transfer belt 17. The intermediate transfer belt 17 secondarily transfers the color image at the position of the secondary transfer roller 14 onto the recording medium 9 conveyed by the sheet feed and conveyance section 5.

After the image is transferred onto the recording medium 9 by the secondary transfer roller 14, the recording medium 9 is conveyed to the fixing section 15. The fixing section 15 includes a heating roller and a pressure roller. The fixing section 15 fixes the image to the recording medium 9 by performing a heating process and a pressurizing process on the recording medium 9 to which the image is transferred.

A reverse path 16 is provided in the conveyance path 12 on the downstream side of the fixing section 15. The reverse path 16 is a conveyance path that reverses the front and back of the recording medium 9 and guides the recording medium 9 to the secondary transfer roller 14 again. In a case where duplex printing is set in the print job, the sheet feed and conveyance section 5 guide the recording medium 9 to a reverse path 16 after an image is formed on a first side of the recording medium 9. The image forming section 6 forms an image on a first surface of the recording medium 9, and then forms an image on a second surface of the recording medium 9 conveyed again. Then, after images are formed on both front and rear surfaces, the recording medium 9 is guided to the sheet ejection device 4 via the color measurement device 3. Note that when the duplex printing is not set in the print job, the recording medium 9 having an image formed on its first side is guided to the sheet ejection device 4 via the color measurement device 3 without passing through the reverse path 16.

When executing a normal print job, the image forming apparatus 2 forms an image on the recording medium 9 based on image data to be printed, and conveys the recording medium 9 to the color measurement device 3 on the downstream side. Further, the image forming apparatus 2 can print images of various charts and supply the printed chart images to the color measurement device 3 on the downstream side, separately from a normal print job. For example, when the execution of the color adjustment process is instructed by the user, the image forming apparatus 2 prints a color measurement chart on the recording medium 9 and supplies the color measurement chart to the color measurement device 3.

When a normal print job is being executed in the image forming apparatus 2, the color measurement device 3 conveys the recording medium 9 received from the image forming apparatus 2 to the sheet ejection device 4 without any processing. On the other hand, when an image of a chart such as a color measurement chart is printed instead of a normal print job in the image forming apparatus 2, the color measurement device 3 executes the color measurement process based on the image of the chart. Details of the color measurement device 3 will be described later.

The sheet ejection device 4 includes, for example, two sheet ejection trays 38 and 39. The sheet ejection device 4 causes a conveyance path 12 along which the recording medium 9 are conveyed to branch into two conveyance paths 12a and 12b, and ejects the recording medium 9 to one of the two sheet ejection trays 38 and 39. For example, when a normal print job is executed in the image forming apparatus 2, the sheet ejection device 4 discharges the recording medium 9 on which an image based on the print job is formed to the sheet ejection tray 38. On the other hand, when an image of a chart such as a color measurement chart has been printed in the image forming apparatus 2, the recording medium 9 on which the image of the chart has been printed is ejected to the sheet ejection tray 39 different from that for a normal print job.

The color measurement device 3 includes an imaging unit 30, a color measurement section 33, and a control unit 34. The imaging unit 30 and the color measurement section 33 are arranged along the conveyance path 12 of the recording medium 9. For example, the imaging unit 30 is arranged on the upstream side of the conveyance path 12 relative to the color measurement section 33. The imaging unit 30 captures an image printed on the recording medium 9 by the image forming section 6. The imaging unit 30 includes two imaging units 31 and 32 so as to be able to read images printed on both the front and back surfaces of the recording medium 9. The image captured by the imaging unit 30 is output to the control unit 34. The color measurement section 33 is arranged on the downstream side of the imaging unit 30, and performs colorimetry on an image printed by the image forming section 6. A color measurement result by the color measurement section 33 is output to the control unit 34. When the colorimetry process is executed in the image forming apparatus 2, the control unit 34 drives the imaging unit 30 and the color measurement section 33, performs colorimetry on an image printed by the image forming apparatus 2, and outputs the color measurement result to the image forming apparatus 2. Next, the control unit 7 of the image forming apparatus 2 adjusts the color on the basis of the color measurement result by the color measurement device 3.

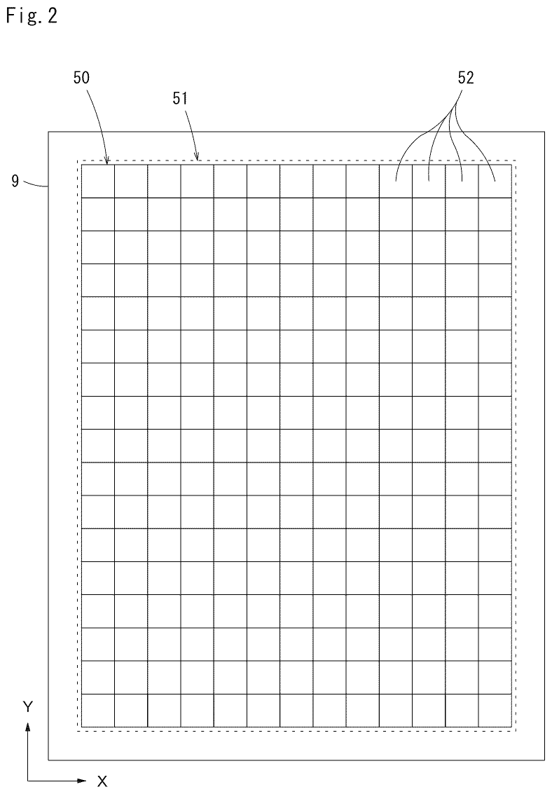

FIG. 2 is a diagram illustrating an example of a color measurement chart 50 printed by the image forming apparatus 2. When the color adjustment processing is executed in the image forming apparatus 2, the color measurement chart 50 as illustrated in FIG. 2 is printed on the recording medium 9. The color measurement chart 50 is an image including a plurality of color patches 52 in a color measurement range 51 set on the recording medium 9. The plurality of color patches 52 are rectangular images having different colors or densities, and are two dimensionally arranged in the X direction and the Y direction in the color measurement range 51.

The control unit 7 of the image forming apparatus 2 holds a reference image serving as a reference data for printing the color measurement chart 50. The color information of each color patch 52 is assigned to the reference image as a reference color. The control unit 7 drives the image forming section 6 based on the reference image to print the color measurement chart 50 on the recording medium 9.

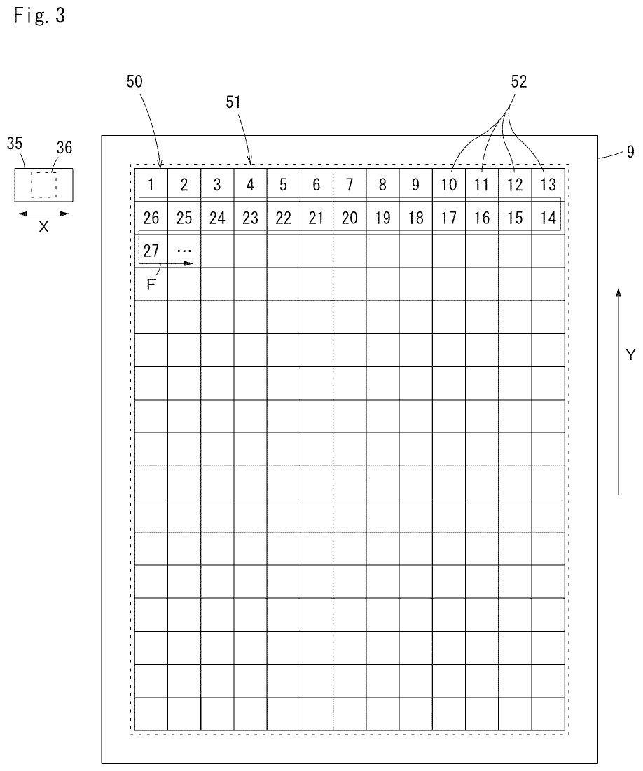

FIG. 3 is a view illustrating an operation example of colorimetry processing by the color measurement section 33. The recording medium 9 on which the color measurement chart 50 is printed is conveyed through the color measurement device 3 in the Y direction. When the recording medium 9 reaches a colorimetry position by the color measurement section 33, the color measurement device 3 temporarily stops the conveyance of the recording medium 9. As illustrated in FIG. 3, the color measurement section 33 includes a color measurement head 35 that is movable in a main scanning direction (X direction) orthogonal to a conveyance direction (Y direction) of the recording medium 9. The color measurement head 35 includes a reading section 36 capable of reading the color of the center of each color patch 52. The color measurement section 33 sequentially reads the colors of the plurality of color patches 52 one by one by intermittently moving the color measurement head 35 in the main scanning direction (X direction) in a state where the conveyance of the recording medium 9 is stopped. For example, when the color of one color patch 52 is read, the color measurement section 33 temporarily stops the movement of the color measurement head 35 in the main scanning direction so that the color at the center of the one color patch 52 can be measured. Next, when the reading by the reading section 36 is completed, the color measurement section 33 restarts the movement of the color measurement head 35. By repeating such an operation, the color measurement section 33 sequentially reads the plurality of color patches 52 arranged in the main scanning direction.

When the color of the color patch 52 positioned at the end in the main scanning direction (X direction) is read, the color measurement device 3 conveys the recording medium 9 in the conveyance direction by a predetermined amount. The conveyance amount at this time corresponds to the length of the color patch 52 in the Y direction. That is, the color measurement device 3 conveys the recording medium 9 so that the color measurement position by the color measurement section 33 can be shifted by one column of the color patches 52. Thereafter, the color measurement device 3 stops the conveyance of the recording medium 9 again, and sequentially reads the colors of the color patches 52 in the second row one by one while moving the color measurement head 35 in the main scanning direction (X direction). That is, the color measurement section 33 sequentially reads the colors of the plurality of color patches 52 as indicated by arrows F in FIG. 3.

The control unit 34 controls the colorimetry operation by the color measurement section 33, and acquires color information obtained by reading each color patch 52 from the color measurement section 33. Then, the control unit 34 records the color information obtained by reading each of the plurality of color patches 52 as a color measurement result.

When finishing the color measurement operation on the color measurement chart 50, the control unit 34 outputs the color measurement result by the color measurement operation to the image forming apparatus 2. The image forming apparatus 2 determines, based on the color measurement result of the color measurement chart 50 acquired from the color measurement device 3, whether or not to perform color adjustment in printing.

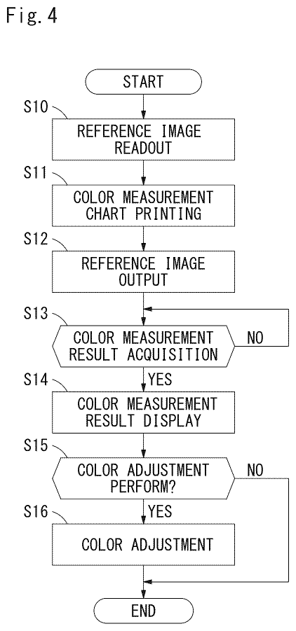

FIG. 4 is a flowchart illustrating an example of a processing procedure performed by the control unit 7 of the image forming apparatus 2 when execution of the color adjustment processing is instructed. For example, when a user instructs the display part 8 of the image forming apparatus 2 to perform color adjustment processing, the control unit 7 starts performing processing based on the flowchart of FIG. 4. Further, the control unit 7 may start the execution of the color adjustment processing not only in response to the instruction from the user but also, for example, before the start of the execution of the print job. Note that when executing the color adjustment processing, the control unit 7 notifies the color measurement device 3 and the sheet ejection device 4 that the color adjustment processing is to be executed.

When starting the processing of the flowchart of FIG. 4, the control unit 7 reads the reference image of the color measurement chart 50 (step S10). Then, the control unit 7 drives the image forming section 6 based on the reference image to print the color measurement chart 50 on the recording medium 9 (step S11). As a result, the recording medium 9 on which the color measurement chart 50 is printed is conveyed to the color measurement device 3. The control unit 7 outputs the reference image to the control unit 34 of the color measurement device 3 (step S12).

After printing the color measurement chart 50, the control unit 7 waits until it acquires a color measurement result from the control unit 34 of the color measurement device 3 (step S13). Upon acquiring the color measurement result (YES in step S13), the control unit 7 displays the color measurement result on the display part 8 (step S14). Thus, the user can determine whether to perform color adjustment based on the color measurement result.

Next, the control unit 7 determines whether to perform color adjustment based on the color measurement result (step S15). For example, the control unit 7 determines, based on an instruction from the user, whether to perform color adjustment. If it is determined that color adjustment is to be performed (YES in step S15), the control unit 7 performs color adjustment, such as updating a color profile to be referred to at the time of printing, based on the color measurement result (step S16). Note that when determining not to perform the color adjustment (NO in step S15), the control unit 7 does not perform the color adjustment based on the color measurement result.

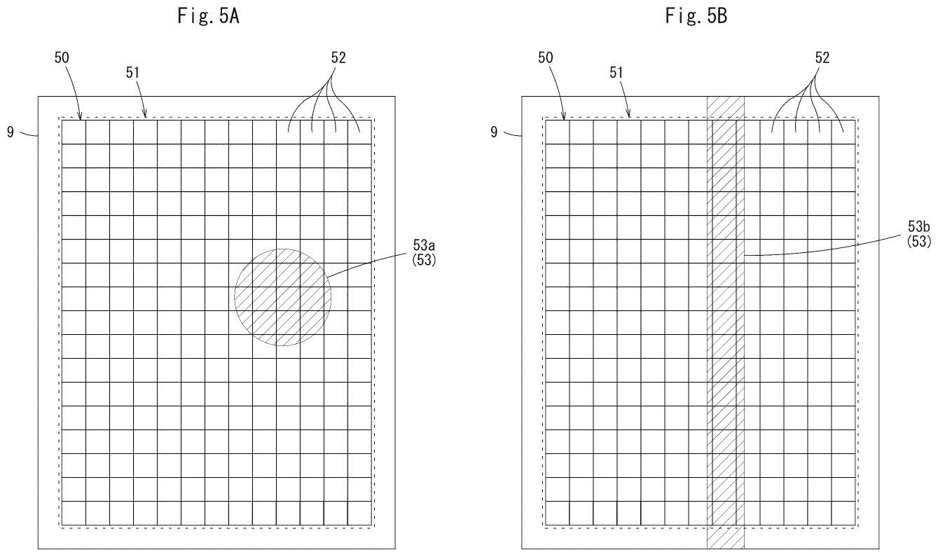

The color measurement chart 50 printed on the recording medium 9 in the image forming section 6 may include image noise. FIGS. 5A and 5B are diagrams illustrating an example of image noise.

The color measurement chart 50 illustrated in FIG. 5A includes a stain 53a appearing in a circular shape as image noise 53. Provided that the stain 53a appearing on the color measurement chart 50 do not necessarily appear in a circular shape, but appear in various shapes. The stain 53a illustrated in FIG. 5A is distributed in a wide range over the plurality of color patches 52. The color patch 52 of the portion where the stain 53a exists is discolored by the stain 53a, and has a color different from the original color (reference color). Such the stain 53a may occur, for example, when dirt or the like adheres to the surfaces of the image bearing members 21 of the image forming units 20Y, 20M, 20C, and 20K. However, the cause of the stain 53a is not necessarily the contamination of the image bearing member 21.

The color measurement chart 50 illustrated in FIG. 5B includes a streak 53b appearing linearly along the conveyance direction (Y direction) of the recording medium 9 as image noise 53. The streak 53b illustrated in FIG. 5B are distributed in a wide range over the plurality of color patches 52 along the conveyance direction of the recording medium 9. The color patch 52 of the portion where the streak 53b exists is discolored by the streak 53b, and has a color different from the original color (reference color). Such a streak 53b may occur due to, for example, uneven charging by the charging device 22, uneven exposure by the exposure device 23, uneven development by the developing device 24, or the like. Provided that the cause of streak 53b is not necessarily limited to charging unevenness, exposure unevenness, and development unevenness.

In addition to the above, the color measurement chart 50 may include image noise 53 such as density unevenness that appears in the main scanning direction (X direction) orthogonal to the conveyance direction (Y direction) of the recording medium 9. Such density unevenness may also occur due to, for example, charging unevenness by the charging device 22, exposure unevenness by the exposure device 23, development unevenness by the developing device 24, or the like. Note that the density unevenness generated in the main scanning direction can be sometimes eliminated by performing density unevenness correction in the main scanning direction.

In the case where the color measurement chart 50 include the image noise 53 as described above, the color measurement result by the color measurement section 33 includes the influence of the image noise 53. Therefore, the color measurement section 33 cannot normally measure the color of the color patch 52 in the portion where the image noise 53 exists. That is, the color measurement section result by the color measurement section 33 becomes an abnormal value.

Therefore, the color measurement device 3 of the present embodiment is configured to capture an image of the color measurement chart 50 by driving the imaging unit 30 and determine whether or not the captured image includes the image noise 53. Hereinafter, the color measurement device 3 of the present embodiment will be described in detail.

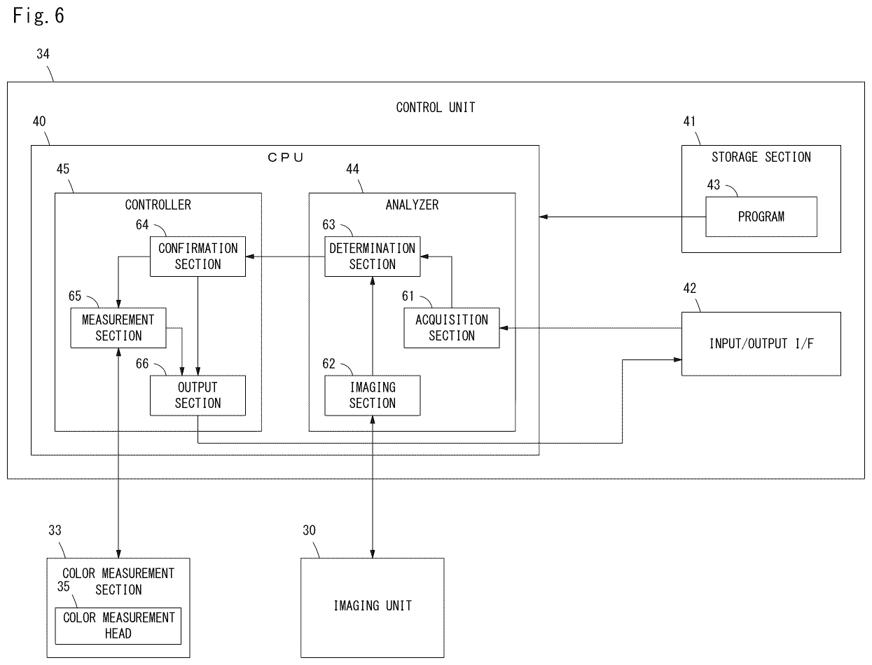

FIG. 6 is a block diagram illustrating the functional configuration of the control unit 34 in the color measurement device 3. The control unit 34 controls the imaging unit 30 and the color measurement section 33. The control unit 34 includes, as a hardware configuration, a CPU40, a storage section 41, and an input/output interface 42. The CPU40 is a hardware processor that reads and executes a computer-readable program 43 stored in the storage section 41. The storage section 41 is a non-volatile storage device including a hard disk drive (HDD), a solid state drive (SSD), or the like. The input/output interface 42 is an interface for communicating with the control unit 7 of the image forming apparatus 2.

When the color adjustment process is executed in the image forming apparatus 2, the CPU40 reads the program 43 from the storage section 41 and executes the program 43. As a result, as shown in FIG. 6, the CPU40 functions as an analyzer 44 and a controller 45. The analyzer 44 analyzes whether or not the color measurement chart 50 printed by the image forming section 6 includes image noise 53 that affects the color measurement result. For example, the analyzer 44 includes an acquisition section 61, an imaging section 62, and a determination section 63. The controller 45 controls the color measurement section 33 based on the analysis result by the analyzer 44. For example, the controller 45 includes a confirmation section 64, a measurement section 65, and an output section 66.

The acquisition section 61 acquires the reference image from the image forming apparatus 2 via the input/output interface 42. The reference image acquired by the acquisition section 61 is image data used for printing the color measurement chart 50. Therefore, even when the color measurement chart 50 printed on the recording medium 9 includes the image noise 53, the reference image does not include the image noise 53. Therefore, the acquisition section 61 acquires the reference image that is the same image as the color measurement chart 50 printed on the recording medium 9 and does not include the image noise 53. Upon acquiring the reference image, the acquisition section 61 outputs the reference image to the determination section 63.

When the recording medium 9 on which the color measurement chart 50 is printed is transported to the color measurement device 3, the imaging section 62 drives the imaging unit 30 to capture an image of the color measurement chart 50. At this time, the imaging section 62 may drive only one imaging unit 31 of the two imaging units 31 and 32 to capture the image of the color measurement chart 50. If the color measurement chart 50 includes the image noise 53, the image noise 53 appears in the image captured by the imaging unit 30. Therefore, the imaging section 62 acquires an image including the image noise 53. The imaging section 62 outputs the image captured by the imaging unit 30 to the determination section 63.

The determination section 63 determines, based on the image captured by the imaging unit 30, whether the image whose color is to be measured by the color measurement section 33 has an abnormality. The determination section 63 extracts a difference between the image captured by the imaging unit 30 and the reference image, and determines whether or not the difference includes any image component. When any image component is included in the difference, the image component corresponds to the image noise 53. Therefore, the determination section 63 can detect the image noise 53 by extracting the difference between the captured image and the reference image.

Upon detection of the image noise 53, the determination section 63 identifies the position, size, shape, and intensity of the image noise 53. The position of the image noise 53 is specified as, for example, a coordinate position in the X direction and the Y direction on the paper surface of the recording medium 9. In addition, by specifying the shape of the image noise 53, the determination section 63 can specify whether the image noise 53 is density unevenness, a streak, or dirt. The intensity of the image noise 53 corresponds to the density of the image noise 53.

Furthermore, the determination section 63 determines whether or not the identified image noise 53 affects the color measurement result by the color measurement section 33. For example, when the image noise 53 is located within the color measurement range 51, the determination section 63 determines that the image noise 53 affects the color measurement result. On the other hand, when the image noise 53 is located outside the color measurement range 51, the determination section 63 determines that the image noise 53 does not affect the color measurement result.

If the image noise 53 is located within the color measurement range 51, the determination section 63 further determines whether each of the plurality of color patches 52 included in the color measurement chart 50 is influenced by the image noise 53. For example, when at least a part of the color patch 52 overlaps with the image noise 53, the determination section 63 determines that the color measurement result of the color patch 52 overlapping with the image noise 53 is influenced by the image noise 53. Then, the determination section 63 outputs the determination result to the controller 45.

As described above, the imaging unit 30 is disposed on the upstream side of the color measurement section 33. Therefore, the analyzer 44 can capture the image of the color measurement chart 50 and output the above-described determination result to the controller 45 before the recording medium 9 reaches the color measurement position by the color measurement section 33.

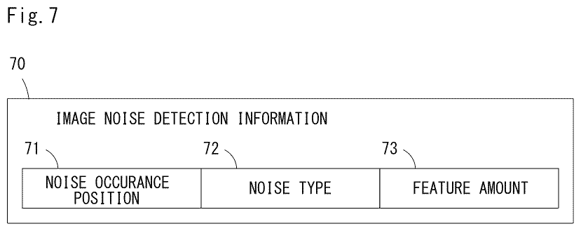

When the image noise 53 is detected from the color measurement chart 50 by the analysis of the analyzer 44, the determination result output from the analyzer 44 to the controller 45 includes image noise detection information. FIG. 7 is a diagram illustrating the image noise detection information 70. As shown in FIG. 7, the image noise detection information 70 includes information on a noise occurrence position 71 indicating the position of the image noise 53, a noise type 72 indicating the type of the image noise 53, and a feature amount 73 indicating the feature of the image noise 53. The noise occurrence position 71 indicates a position where the image noise 53 is included on the paper surface of the recording medium 9. The noise type 72 indicates whether the image noise 53 is density unevenness, a streak, or a stain. The feature amount 73 indicates the intensity of the image noise 53. When the image noise detection information 70 is output from the analyzer 44 to the controller 45, the controller 45 can transmit information regarding the image noise 53 included in the color measurement chart 50 to the image forming apparatus 2.

The confirmation section 64 acquires an analysis result (determination result) by the analyzer 44 and confirms the analysis result. Next, the confirmation section 64 identifies the color patch 52 affected by the image noise 53 from among the plurality of color patches 52 included in the color measurement chart 50 printed on the recording medium 9. Upon identifying the color patch 52 affected by the image noise 53, the confirmation section 64 notifies the measurement section 65 of the color patch 52. The confirmation section 64 also notifies the output section 66 of the color patch 52 affected by the image noise 53. Furthermore, when acquiring the image noise detection information 70 from the analyzer 44, the confirmation section 64 outputs the image noise detection information 70 to the output section 66.

The measurement section 65 drives the color measurement section 33 and controls the color measurement operation performed by the color measurement section 33. Then, the measurement section 65 acquires the color measurement result from the color measurement section 33. However, the measurement section 65 does not acquire the color measurement result of the image in a case where there is an abnormality in the image subjected to color measurement by the color measurement section 33.

When there is a color patch 52 affected by the image noise 53 among the plurality of color patches 52 included in the color measurement chart 50, the measurement section 65 does not measure the color of the color patch 52. For example, when the measurement section 65 moves the color measurement head 35 along the arrow F shown in FIG. 3, the measurement section 65 does not stop the color measurement head 35 at the position where the color patch 52 affected by the image noise 53 is measured, and does not perform the reading operation by the color measurement head 35. That is, the measurement section 65 skips the measurement operation for the color patches 52 affected by the image noise 53 and moves the color measurement head 35, thereby reducing the time required for measuring the color of the entire color measurement chart 50.

In other words, the measurement section 65 selects only the color patch 52 which is not influenced by the image noise 53 among the plurality of color patches 52 included in the color measurement chart 50 and performs the color measurement. As a result, the measurement section 65 acquires the color measurement values of the color patches 52 not affected by the image noise 53 among the plurality of color patches 52 included in the color measurement chart 50. The measurement section 65 calculates the color difference between the color measurement value and the reference color. Therefore, the color measurement result of the color patch 52 includes at least the color measurement value and the color difference. The measurement section 65 then outputs the color patch 52 and the color measurement result in association with each other to the output section 66.

The output section 66 outputs the color measurement results of the color measurement chart 50 to the control unit 7 of the image forming apparatus 2. The color measurement results output from the output section 66 do not include the color measurement results of the color patches 52 affected by the image noise 53. Therefore, the influence of the image noise 53 is not reflected in the color adjustment performed in the control unit 7. As a result, the image forming apparatus 2 can perform highly accurate color adjustment, thereby improving color reproducibility in printing.

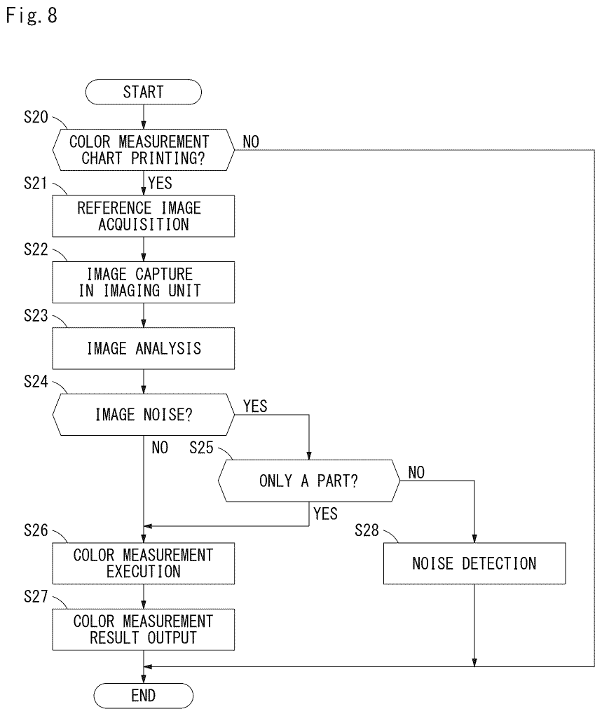

FIG. 8 is a flowchart illustrating an example of a processing procedure by the control unit 34 of the color measurement device 3. This processing is performed by the CPU40 of the control unit 34 executing the program 43. As illustrated in FIG. 8, the control unit 34 determines whether printing of the color measurement chart 50 is performed in the image forming apparatus 2 (step S20). If the image forming apparatus 2 does not print the color measurement chart 50 (NO in step S20), the process ends.

If the color measurement chart 50 is to be printed (YES in step S20), the control unit 34 acquires the reference image of the color measurement chart 50 from the image forming apparatus 2 (step S21). Then, the control unit 34 waits until the recording medium 9 on which the color measurement chart 50 is printed reaches the imaging position of the imaging unit 30, and when detecting that the recording medium 9 has reached the imaging position, the control unit 34 drives the imaging unit 30 to capture an image of the color measurement chart 50 (step S22).

When the image of the color measurement chart 50 is captured, the control unit 34 performs image analysis by the analyzer 44 (step S23). That is, the control unit 34 determines whether or not the image noise 53 is included in the color measurement chart 50 printed on the recording medium 9.

Subsequently, the control unit 34 determines whether the color measurement chart 50 includes image noise 53 (step S24). When the image noise 53 is included (YES in Step S24), the control unit 34 further determines whether or not the image noise 53 exists only in a part of the color measurement chart 50 (Step S25).

When the image noise 53 is not included in the color measurement chart 50 (NO in step S24), or when the image noise 53 is included in only a part of the color measurement chart 50 (YES in step S25), the control unit 34 executes the color measurement operation (step S26). For example, when the image noise 53 is not included in the color measurement chart 50 (NO in step S24), the control unit 34 sets all of the plurality of color patches 52 included in the color measurement chart 50 as the color measurement target. On the other hand, in a case where the image noise 53 is included only in a part of the color measurement chart 50 (YES in step S25), the control unit 34 sets the color patch 52 which does not include the image noise 53 among the plurality of color patches 52 as the color measurement target. Then, the control unit 34 drives the color measurement section 33 and executes color measurement of the color patch 52 set as the color measurement target. When the color measurement of the color patch 52 set as the color measurement target is completed, the control unit 34 outputs the color measurement result to the image forming apparatus 2 (step S27).

On the other hand, when the image noise 53 is included in the entirety of the color measurement chart 50 rather than in a part of the color measurement chart 50 (NO in step S25), the control unit 34 does not perform the color measurement operation and outputs the detection result of the image noise 53 to the image forming apparatus 2 (step S28). At this time, the control unit 34 outputs, for example, the image noise detection information 70 illustrated in FIG. 7 to the image forming apparatus 2.

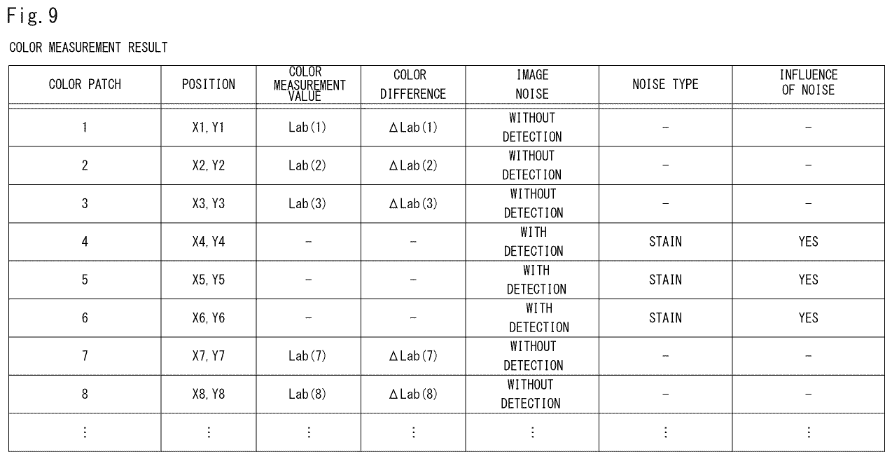

FIG. 9 is a diagram illustrating an example of a color measurement result output from the color measurement device 3 to the image forming apparatus 2. As illustrated in FIG. 9, the color measurement result is information in which a position, a color measurement value, a color difference, image noise, a noise type, and an influence of noise are recorded for each color patch 52 included in the color measurement chart 50. The color measurement device 3 does not perform color measurement on the color patch 52 in which image noise 53 is detected. Therefore, in the color measurement results illustrated in FIG. 9, the columns of the color measurement value and the color difference corresponding to the color patch 52 in which the image noise 53 is detected are left blank. On the other hand, information regarding the image noise 53 detected by the control unit 34 is recorded in the columns of the image noise, the noise type, and the influence of the noise. The color measurement device 3 outputs such a color measurement result to the image forming apparatus 2.

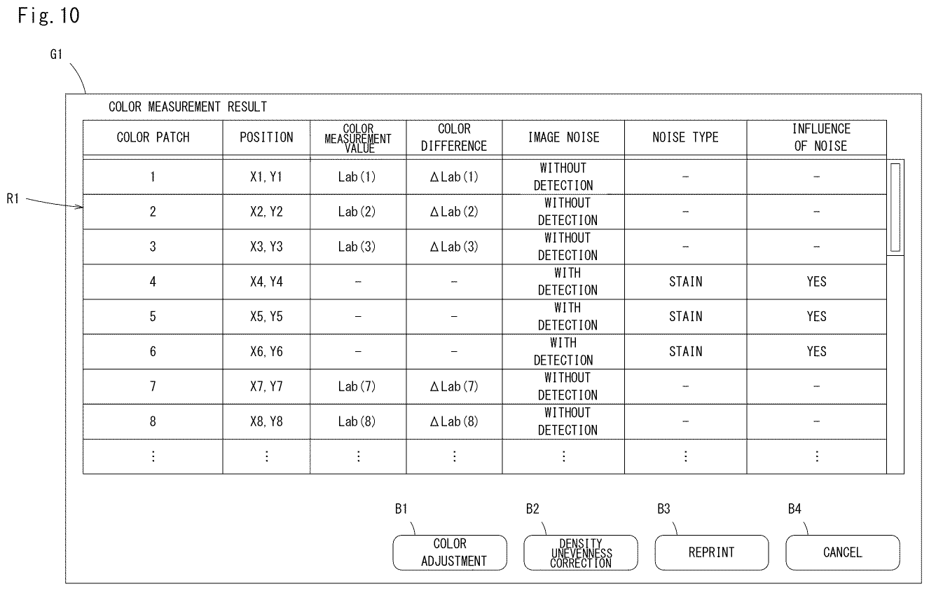

Upon acquiring the color measurement result from the color measurement device 3, the image forming apparatus 2 displays the color measurement result on the display part 8. FIG. 10 is a view illustrating an example of a display screen G1 for color measurement results displayed on the display part 8. The display screen G1 shown in FIG. 10 has a color measurement result display region R1 for displaying the color measurement result by the color measurement device 3. Therefore, the user can confirm whether or not the color measurement of each color patch 52 included in the color measurement chart 50 is normally performed by viewing the color measurement result displayed in the color measurement result display region R1. For example, in the field of the color patch 52 including the image noise 53, the image noise, the noise type, and the influence of the noise are displayed. Therefore, the user can grasp details of the image noise 53 included in each color patch 52.

The display screen G1 displays, below the color measurement result display region R1, a plurality of operation buttons B1 to B4 that can be operated by the user.

The operation button B1 is a button for giving an instruction to perform color adjustment based on a color measurement result. When the control unit 7 detects that the operation button B1 is operated, the control unit 7 performs color adjustment based on the color measurement result. That is, the control unit 7 performs the color adjustment by updating the color profile based on the color measurement value and the color difference of each color patch 52 included in the color measurement result. At this time, the color patch 52 affected by the image noise 53 does not include the color measurement value and the color difference. Therefore, the control unit 7 does not use the color measurement result of the color patch 52 affected by the image noise 53 in the color adjustment. As a result, the control unit 7 can perform the color adjustment excluding the influence of the image noise 53.

The operation button B2 is a button for instructing the image forming apparatus 2 to perform density unevenness correction. The density unevenness correction is, for example, a process of correcting density unevenness occurring in the main scanning direction of the recording medium 9 by changing the exposure intensity of the exposure device 23 along the axial direction (main scanning direction) of the image bearing member 21. Upon detecting that the operation button B2 has been operated, the control unit 7 performs density unevenness correction.

The operation button B3 is a button for instructing the image forming apparatus 2 to reprint the color measurement chart 50. For example, when most of the color patches 52 included in the color measurement chart 50 are affected by the image noise 53, appropriate color adjustment cannot be performed even if the color adjustment based on the color measurement result is performed. Therefore, a user performs maintenance such as cleaning of a component that may cause the image noise 53. Next, after performing maintenance, the user may instruct reprinting of the color measurement chart 50. The operation button B3 is a button to be operated by the user for the reprinting.

When the operation button B3 is operated by the user, the image forming apparatus 2 prints the color measurement chart 50 again. In this case, the color measurement device 3 executes the above-described color measurement operation again on the recording medium 9 on which the color measurement chart 50 is printed. When the control unit 34 of the color measurement device 3 performs color measurement on the color measurement chart 50 which is printed again, the control unit 34 selects only the color patch 52 which is not subjected to color measurement in the previous time among the plurality of color patches 52 included in the color measurement chart 50, and performs color measurement. That is, the color measurement section 33 skips the color patch 52 subjected to the previous color measurement and proceeds with the color measurement operation. Accordingly, it is possible to efficiently perform the color measurement operation of the reprinted color measurement chart 50.

The operation button B4 is a button for canceling the execution of the color adjustment processing in the middle. When the display screen G1 is operated by the user while the operation button B4 is displayed, the image forming apparatus 2 ends the color adjustment processing without performing the color adjustment.

As described above, the image forming system 1 according to the present embodiment includes the color measurement section 33 that measures the color of the image printed on the recording medium 9 by the image forming section 6 in order to improve color reproducibility. In addition, the image forming system 1 includes an analyzer 44 that analyzes whether or not there is an abnormality in the image subjected to colorimetry by the color measurement section 33 on the basis of the image captured by the imaging unit 30. When the analyzer 44 determines that the image has an abnormality, the color measurement section 33 is configured not to output at least the color measurement result of the image having an abnormality. The image forming system 1 having such a configuration can execute color adjustment based on a color measurement result obtained by performing color measurement only on an image having no abnormality. That is, since the color of the image having the abnormality is not reflected in the color adjustment, it is possible to enhance the reproducibility of the color.

### Second Embodiment

Next, a second embodiment of the present invention will be described. In the first embodiment described above, an example in which the image noise 53 is detected by comparing the image of the color measurement chart 50 with the reference image has been described. However, it is difficult to determine which of the plurality of image forming units 20Y, 20M, 20C, and 20K is the cause of the image noise 53 by the method of detecting the image noise 53 described in the first embodiment. Therefore, in the present embodiment, an example in which it is possible to easily specify which of the plurality of image forming units 20Y, 20M, 20C, and 20K is the cause of the image noise 53 will be described. The configuration of the image forming system 1 in the present embodiment is the same as the configuration described in the first embodiment.

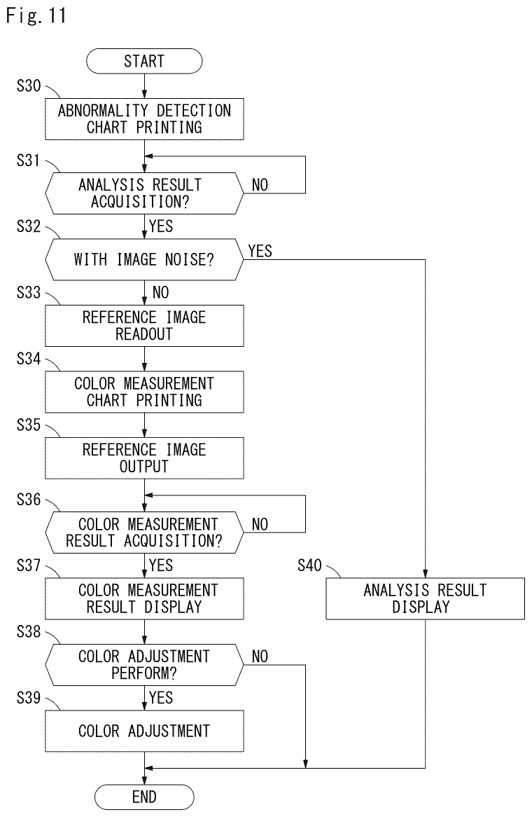

FIG. 11 is a flowchart illustrating an example of a processing procedure performed by the control unit 7 of the image forming apparatus 2 when the execution of the color adjustment processing is instructed in the present embodiment. When starting the processing based on the flowchart of FIG. 11, the control unit 7 prints the abnormality detection chart on the recording medium 9 (step S30). The abnormality detection chart is an image for detecting image abnormality. The abnormality detection chart is printed on the recording medium 9 prior to printing of the color measurement chart 50.

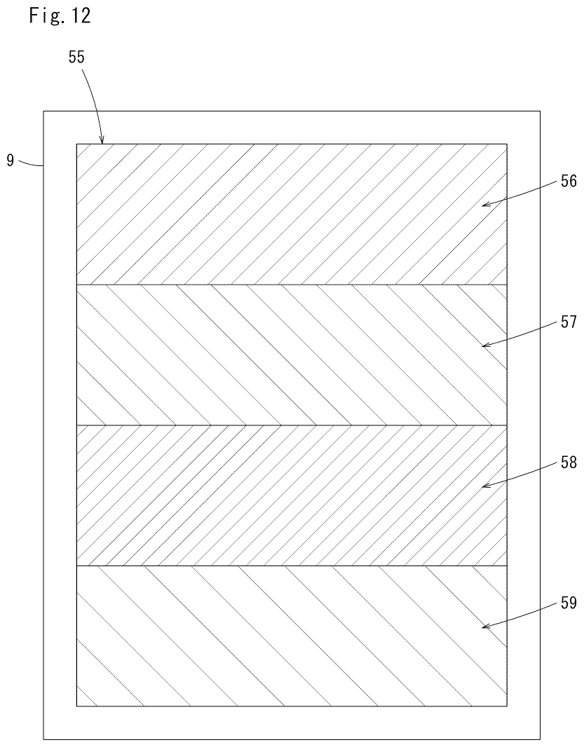

FIG. 12 is a diagram illustrating an example of the abnormality detection chart 55 printed in the image forming apparatus 2. When the color adjustment processing is executed in the image forming apparatus 2, an abnormality detection chart 55 as illustrated in FIG. 12 is printed on the recording medium 9. The abnormality detection chart 55 includes a first chart 56 on which Y color having a predetermined density is printed, a second chart 57 on which M color having a predetermined density is printed, a third chart 58 on which C color having a predetermined density is printed, and a fourth chart 59 on which K color having a predetermined density is printed. The first chart 56 includes only the image formed by the image forming unit 20Y. The second chart 57 includes only the image formed by the image forming unit 20M. The third chart 58 includes only an image formed by the image forming unit 20C. The fourth chart 59 includes only an image formed by the image forming unit 20K.

When the recording medium 9 on which the abnormality detection chart 55 is printed by the image forming apparatus 2 is carried into the color measurement device 3, the color measurement device 3 captures an image of the abnormality detection chart 55 and performs image analysis of the abnormality detection chart 55. The color measurement device 3 outputs the analysis result to the control unit 7 of the image forming apparatus 2.

Return to the flowchart of FIG. 11. After printing the abnormality detection chart 55, the control unit 7 waits until it acquires an analysis result from the color measurement device 3 (step S31). When the analysis result is acquired (step S31), the control unit 7 determines whether or not the image noise 53 is included in the abnormality detection chart 55 based on the analysis result (step S32).

If the image noise 53 is not included (NO in step S32), the control unit 7 executes the processing in step S33 and subsequent steps. The processes of steps S33 to S39 are the same as the processes of steps S10 to S16 illustrated in FIG. 4. Therefore, the image forming apparatus 2 prints the color measurement chart 50 on the recording medium 9, conveys the recording medium 9 to the color measurement device 3, acquires the color measurement result from the color measurement device 3, and displays the color measurement result on the display part 8 (steps S33 to S37). When the color adjustment is to be performed (YES in step S38), the image forming apparatus 2 performs the color adjustment based on the color measurement result (step S39).

On the other hand, when the image noise 53 is included in the abnormality detection chart 55 (YES in step S32), the control unit 7 displays the analysis result in the color measurement device 3 on the display part 8 (step S40). Note that when the image noise 53 is included in the abnormality detection chart 55, the image forming apparatus 2 does not print the color measurement chart 50.

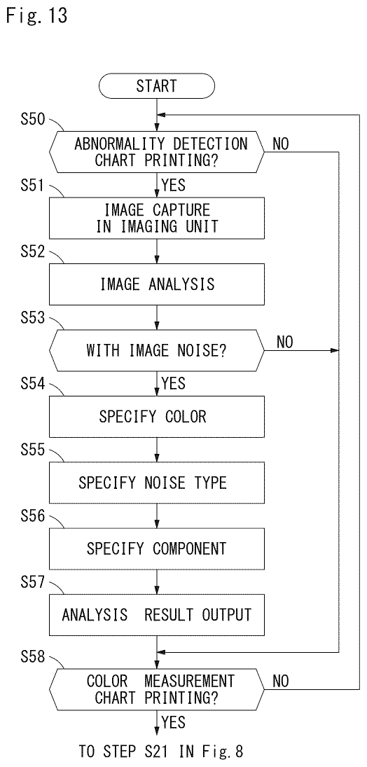

Next, a processing procedure in the color measurement device 3 will be described. FIG. 13 is a flowchart illustrating an example of a processing procedure by the control unit 34 of the color measurement device 3. As illustrated in FIG. 13, the control unit 34 determines whether printing of the abnormality detection chart 55 is performed in the image forming apparatus 2 (step S50). When the printing of the abnormality detection chart 55 is not performed (NO in step S50), the process by the control unit 34 proceeds to step S58.

When the printing of the abnormality detection chart 55 is performed (YES in step S50), the control unit 34 waits until the recording medium 9 on which the abnormality detection chart 55 is printed reaches the imaging position of the imaging unit 30. When detecting that the recording medium 9 has reached the imaging position, the control unit 34 drives the imaging unit 30 to capture an image of the abnormality detection chart 55 (step S51).

When the image of the abnormality detection chart 55 is captured, the control unit 34 performs image analysis by the analyzer 44 (step S52). That is, the analyzer 44 determines whether the abnormality detection chart 55 printed on the recording medium 9 contains image noise 53. For example, the analyzer 44 extracts a first chart 56, a second chart 57, a third chart 58, and a fourth chart 59 from the abnormality detection chart 55. Next, the analyzer 44 determines whether or not image noise 53 such as density unevenness, dirt, or a streak exists in each of the first through fourth charts 56 through 59. That is, the analyzer 44 determines whether or not the image noise 53 exists for each of the colors of Y, M, C, and K constituting the color image.

After performing image analysis, the analyzer 44 determines whether image noise 53 has been detected (step S53). As a result, when the image noise 53 is not detected (NO in step S53), the process by the control unit 34 proceeds to step S58. On the other hand, when the image noise 53 is detected (YES in step S53), the analyzer 44 specifies the color of the image noise 53 (step S54). Subsequently, the analyzer 44 identifies the type of the image noise 53 included in the abnormality detection chart 55 (step S55). That is, the analyzer 44 identifies which of the density unevenness, the streak, and the dirt the image noise 53 included in the identified color is.

By identifying the color in which the image noise 53 occurs, the analyzer 44 can identify which of the plurality of image forming units 20Y, 20M, 20C, and 20K is the cause of the image noise 53. Furthermore, by identifying the type of the image noise 53, the analyzer 44 can identify which of the image bearing member 21, the charging device 22, the exposure device 23, and the developing device 24 is the cause of the image noise 53. Therefore, the analyzer 44 identifies the component causing the image noise 53, based on the identification results of step S54 and S55 (step S56). At this time, the analyzer 44 may specify not only one component but also a plurality of components. When the analyzer 44 specifies the component causing the image noise 53, the analyzer 44 outputs the detection result of the image noise 53 and the analysis result indicating the recommended countermeasure to the image forming apparatus 2 (step S57).

When the analysis result is output to the image forming apparatus 2, the processing by the control unit 34 proceeds to step S58. Then, the control unit 34 determines whether or not printing of the color measurement chart 50 is performed in the image forming apparatus 2 (step S58). When the color measurement chart 50 is not printed (NO in step S58), the process by the control unit 34 returns to step S1. On the other hand, when the color measurement chart 50 is to be printed (YES in step S58), the control unit 34 executes the processing in step S21 and subsequent steps illustrated in FIG. 8. That is, the control unit 34 executes the same processing as the processing described in the first embodiment.

By performing the above-described processing, the color measurement device 3 can identify in which color of the plurality of colors of Y, M, C, and K the image noise 53 occurs, and can also identify the component causing the image noise 53. Next, the color measurement device 3 determines a recommended countermeasure against the image noise 53 based on the identification result, and outputs an analysis result to the image forming apparatus 2.

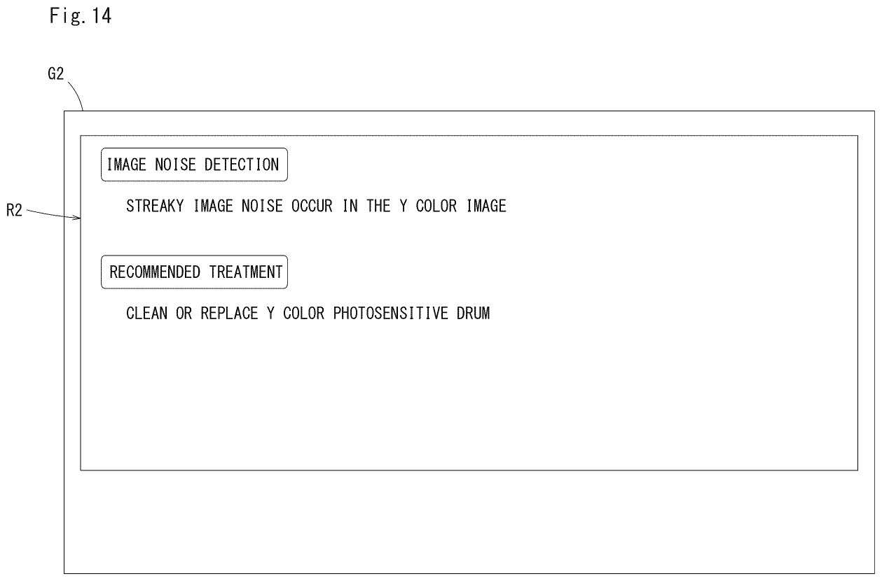

Therefore, when displaying the analysis result output from the color measurement device 3, the image forming apparatus 2 can guide the user to the details of the image noise 53 and how to deal with the image noise 53. FIG. 14 is a diagram illustrating an example of a display screen G2 displayed on the display part 8 in step S40 of FIG. 11. The display screen G2 includes a display region R2 in which an analysis result of the image of the abnormality detection chart 55 by the color measurement device 3 is displayed. When the image noise 53 is detected from the abnormality detection chart 55, the detection result of the image noise 53 and the recommended target method are displayed in the display region R2. Therefore, the user can eliminate the image noise 53 by performing the maintenance work based on the coping method guided on the display screen G2.

As described above, the image forming system 1 according to the present embodiment prints, on the recording medium 9, the abnormality detection chart 55 for detecting image abnormality, separately from the color measurement chart 50. The imaging unit 30 captures an image of the abnormality detection chart 55 printed on the recording medium 9. The analyzer 44 analyzes, based on the image captured by the imaging unit 30, whether or not the image of the abnormality detection chart 55 has an abnormality such as image noise 53. When there is an abnormality in the image of the abnormality detection chart 55, the analyzer 44 specifies a component that is the cause of the abnormality. Therefore, in a case where an abnormality such as the image noise 53 occurs during printing, the image forming system 1 can notify a user of a component that needs maintenance in order to resolve the abnormality.

Furthermore, the image forming system 1 prints the color measurement chart 50 if the analyzer 44 determines that the image of the abnormality detection chart 55 has no abnormality. The color measurement device 3 measures the colors of images included in the color measurement chart 50. By performing color adjustment based on the color measurement result, the image forming system 1 can increase the reproducibility of colors in printing.

### MODIFICATIONS

A preferred embodiment of the present invention has been described above. However, the present invention is not limited to the content described in the above embodiment, and various modification examples are applicable.

First, the above embodiment described an example in which the function of the analyzer 44 is incorporated in the control unit 34 of the color measurement device 3. However, the function of the analyzer 44 may be provided in a unit different from the control unit 34. In that case, a unit having the function of the analyzer 44 may be provided as, for example, an external device of the color measurement device 3. For example, the function of the analyzer 44 may be installed in a personal computer (PC) or the like that is communicably connected to the color measurement device 3.

Second, the control unit 34 of the color measurement device 3 may be provided outside the color measurement device 3. For example, the functions of the control unit 34 described above may be incorporated in a personal computer (PC) or the like that is communicably connected to the color measurement device 3.

Thirdly, in the embodiment described above, the case where the program 43 to be executed by the CPU40 of the control unit 34 is stored in advance in the storage section 41 has been illustrated. However, the program 43 is not limited to a program stored in the storage section 41 in advance. That is, the program 43 can be a target of trading by itself. In this case, the program 43 may be provided in a state of being recorded in a portable non-transitory computer-readable recording medium such as a CD-ROM or a USB memory, or may be provided in a mode of being downloadable through a network such as the Internet.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming system comprising:
an image forming section that prints an image on a recording medium and outputs the recording medium;
a color measurement section that measures color of the image printed by the image forming section;
an imaging unit that captures the image printed by the image forming section; and
an analyzer that analyzes, based on the image captured by the imaging unit, whether or not the image subjected to color measurement by the color measurement section has an abnormality, wherein
the color measurement section does not output, when the analyzer determines that the image has an abnormality, a color measurement result of the image having the abnormality.

2. The image forming system according to claim 1, wherein
the image forming section prints a color measurement chart, and
the color measurement section performs color measurement of images included in the color measurement chart.

3. The image forming system according to claim 2, wherein
the color measurement chart includes a plurality of color patches within a color measurement range by the color measurement section, and
the color measurement section is capable of performing color measurement of the plurality of color patches one by one.

4. The image forming system according to claim 3, wherein
the analyzer detects image noise within the color measurement range as an abnormality.

5. The image forming system according to claim 4, wherein
the image noise is at least one of density unevenness, streak, and stain.

6. The image forming system according to claim 5, wherein
the color measurement section selects, based on a position where the image noise is detected by the analyzer, a color patch without the image noise from among the plurality of color patches and performs color measurement of the selected color patch.

7. The image forming system according to claim 2, wherein
the color measurement section does not perform color measurement of the image included in the color measurement chart when the analyzer determines that there is abnormality in the image.

8. The image forming system according to claim 2, wherein
the color measurement section performs color measurement of the image included in the color measurement chart when the analyzer determines that the image has no abnormality.

9. The image forming system according to claim 2, wherein
the color measurement section does not perform, when the analyzer determines that there is an abnormality in a part of the images, color measurement of the image located at a position where the abnormality is detected among the images included in the color measurement chart, and performs color measurement of the image located at a position where the abnormality is not detected.

10. The image forming system according to claim 9, wherein
the image forming section prints the color measurement chart again after the abnormality of the image is solved, and
when performing color measurement on the reprinted color measurement chart, the color measurement section performs color measurement of an image that has not been subjected to color measurement previously among images included in the color measurement chart.

11. The image forming system according to claim 3, further comprising:
a display part that displays, in a case where the analyzer determines that the image has an abnormality,
a color patch at a position where the abnormality is detected and a color patch at a position where no abnormality is detected, among the plurality of color patches, in a distinguishable manner.

12. The image forming system according to claim 6, further comprising:
a display part that displays a color measurement result of a color patch selected from the plurality of color patches and subjected to color measurement.

13. The image forming system according to claim 2, wherein
the image forming section prints an abnormality detection chart for detecting image abnormality,
separately from the color measurement chart,
the imaging unit captures an image of the abnormality detection chart, and
the analyzer analyzes whether the image of the abnormality detection chart has an abnormality.

14. The image forming system according to claim 13, wherein
the analyzer specifies a component which is an abnormality occurrence cause when there is an abnormality in the image based on an analysis result of the abnormality detection chart.

15. The image forming system according to claim 14, further comprising:
a display part that displays the component identified by the analyzer.

16. The image forming system according to claim 13, wherein
the image forming section prints the color measurement chart when the analyzer determines that the image of the abnormality detection chart has no abnormality, and
the color measurement section performs color measurement of the images included in the color measurement chart.

17. A color measurement device comprising:
a color measurement section that measures color of an image printed on a recording medium;
an imaging unit that captures the image printed on the recording medium; and
an analyzer that analyzes, based on the image captured by the imaging unit, whether or not the image subjected to color measurement by the color measurement section has an abnormality, wherein
the color measurement section does not output, when the analyzer determines that the image has an abnormality, a color measurement result of the image having the abnormality.

18. A non-transitory computer-readable recording media recorded thereon a program to be executed by a hardware processor of a computer in a color measurement device including a color measurement section that measures color of an image printed on a recording medium and an imaging unit that captures the image printed on the recording medium, the program causing the hardware processor to perform:
analyzing, based on the image captured by the imaging unit, whether or not the image subjected to color measurement by the color measurement section has an abnormality, and
controlling the color measurement section so as not to output, when it is determined by analyzing that the image has an abnormality, a color measurement result of the image having the abnormality.
